(19) United States
(12) Patent Application Publication
(10) Pub. No.: US 2012/0024085 A1
(43) Pub. Date: Feb. 2, 2012

(54) Sample vial cap

(76) Inventors: Michael T. Faulkner, Leominster, MA (US); Johnson C. Watkins, Newark, DE (US); Paul Petrosino, Schoharie, NY (US)

(21) Appl. No.: 12/804,759

(22) Filed: Jul. 28, 2010

(51) Int. Cl. B01L 3/00; B29C 39/02

(52) U.S. Cl. 73/864.91; 422/568; 422/63; 264/299

(57) ABSTRACT

A sample vial cap typically including a top portion made of plastic material and including an aperture and a septum about the aperture. A wall depends downward from the top. A ferromagnetic substance is included in the plastic material of at least the top portion.

### FIELD OF THE INVENTION

The subject invention relates to sample vials and caps therefore typically including a septum used in automated sample handling equipment in the chemical analysis and life science industries.

### BACKGROUND OF THE INVENTION

In the chemical analysis and life science industries, sample vials are used, sealed with a cap including a septum. A syringe, piercing the septum, can be used to remove a portion of the sample in the vial or to add fluid to the vial. See U.S. Pat. No. 5,707,589 incorporated herein by this reference.

Automated sample handling equipment is now becoming more and more popular. Typically, such equipment includes robotic handlers which move trays of sample vials and/or pick and place handlers which grasp and move individual vials.

In some new equipment, magnetic handlers are used. “LEAP PAL” sample handlers and “CTC Analytics” handler are examples. Since the sample vials and caps currently available on the market were made of plastic or glass, manufacturers have begun to add a metal layer over or within the vial cap so that the vial can be retrieved and handled by the new magnetic handlers. Certain plastic caps, specifically thermoset plastics, for example phenolic, are also known to be brittle and consequently break or develop cracks under normal use conditions and assembly with the metal layer.

The expense and labor associated with such techniques, however, are unfavorable.

### BRIEF SUMMARY OF THE INVENTION

The subject invention features, in one example, a new plastic vial cap which can be made in a less expensive and less labor intensive manner. In one preferred embodiment, the vial cap includes a thermoplastic component containing sufficient material to impart effective attraction to the magnetic head of a handler used in new automatic sampling handling equipment.

The subject invention features a sample vial cap comprising a top portion made of plastic material and including an aperture, a septum about the aperture, a wall depending downward from the top, and a ferromagnetic substance included in the plastic material of the top portion. In this way, the vial cap is attracted to the magnetic head of a handler.

In one example, the cap wall also includes plastic material with a ferromagnetic substance therein. Typically, the top portion and wall are molded using a plastic material including a ferromagnetic substance therein. In one version, the ferromagnetic substance includes powders or flakes of metal such as stainless steel, iron, and/or magnetic iron oxide. The wall may include threads.

In one design, the sample vial cap comprises a top portion made of plastic material and including an aperture, a septum about the aperture, a plastic wall depending downward from the top portion, and metal powders or flakes included in the plastic material of the top portion and the wall.

The subject invention also features a method of making a sample vial cap. One preferred method includes mixing a ferromagnetic substance with a plastic material, adding the mixture into a mold configured to produce a sample vial cap with an opening for a septum, molding the cap, and adding a septum about the opening.

An automated sample handling apparatus in accordance with the subject invention includes a handler with a magnetic head used to retrieve and deposit sample vials sealed with caps each having a septum. Each said cap includes a ferromagnetic substance therein for attraction to the magnetic head. Typically, the cap is made of a molded plastic material with metal powders or flakes mixed therein.

The subject invention also features a sample vial cap which includes a plastic component and a ferromagnetic substance which is added to the plastic component. The plastic component may include a top portion with an opening sealed by a septum, an insert between a top portion with an opening and a septum disk sealing the opening, or a solid top portion with a wall depending downward therefrom.

The subject invention also features a sample vial crimp cap including a top portion with an opening, a plastic insert with a ferromagnetic substance therein, and a septum disk behind the plastic insert.

The subject invention also features a method of automatically handling samples. Plastic caps are formed for vials to include a ferromagnetic substance mixed therein. A sample is placed in a vial and the vial is sealed with the formed plastic cap. A handler with a magnetic head is employed to move the vial via magnetic attraction between the magnetic head and the vial cap.

In one method, forming may include adding an effective magnetic attraction composition of between 60-85% by weight of the ferromagnetic substance to 15-40% by weight of a polymer composition. Approximately 70% iron powder may be added to approximately 30% by weight of a polymer composition. The polymer composition may include a homopolymer and a copolymer polypropylene.

A thermoplastic polymer containing a filler in an effective magnetic attraction amount is formed into a vial cap. The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a highly schematic three-dimensional exploded front view showing an example of a vial cap with a metal layer laid over it in accordance with the prior art;

FIG. 2 is a schematic cross-sectional side view of the cap shown in FIG. 1;

FIG. 3 is a schematic three-dimensional exploded front view of another example of a vial cap with a metal insert in accordance with the prior art;

FIG. 4 is a schematic three-dimensional side view showing an example of a new plastic vial cap in accordance with the subject invention;

FIG. 5 is a schematic cross-sectional side view of the cap shown in FIG. 4;

FIG. 6 is a schematic flow chart depicting the primary steps associated with manufacturing the vial cap in accordance with an example of the subject invention;

FIG. 7 is a schematic front view of an automatic sample handling equipment head retrieving a vial sealed with a sample cap in accordance with the subject invention;

FIG. 8 is a schematic exploded view of a vial crimp cap including a plastic insert in accordance with the prior art;

FIG. 9 is a schematic exploded view of a vial crimp cap with a plastic insert in accordance with an example of the subject invention; and

FIG. 10 is a schematic three-dimensional front view of a screw or snap cap for a vial in accordance with the subject invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

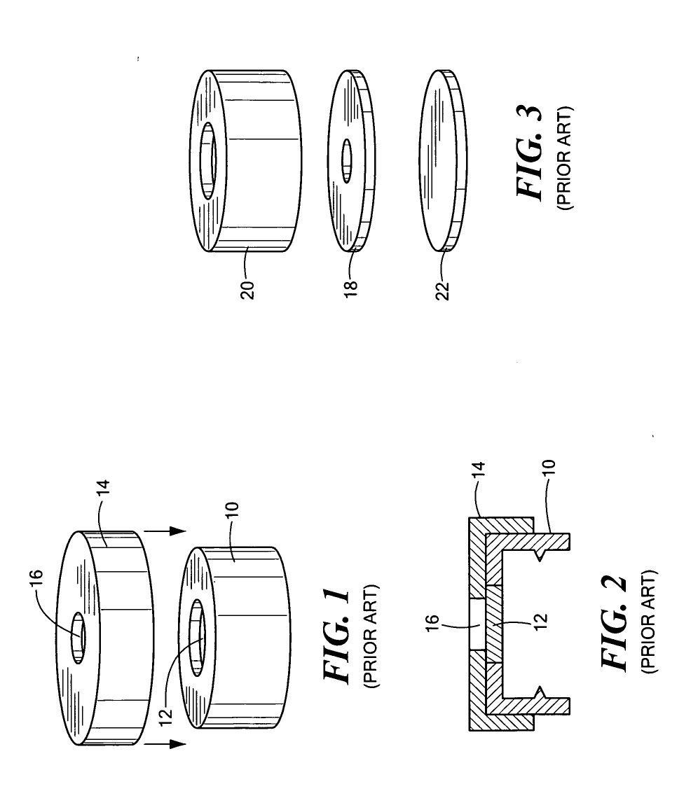

The Background Section above describes how new automated sample handling equipment includes magnetic heads used to transport vials sealed with a septum type cap. Accordingly, those skilled in the art have added, to standard plastic cap 10, FIGS. 1-2 with septum 12, a metal cover 14 with septum opening 16. Such a process is labor intensive and costly. Those skilled in the art have also added a steel insert 18, FIG. 3 inside aluminum crimp cap 20 between cap 20 and septum disk 22.

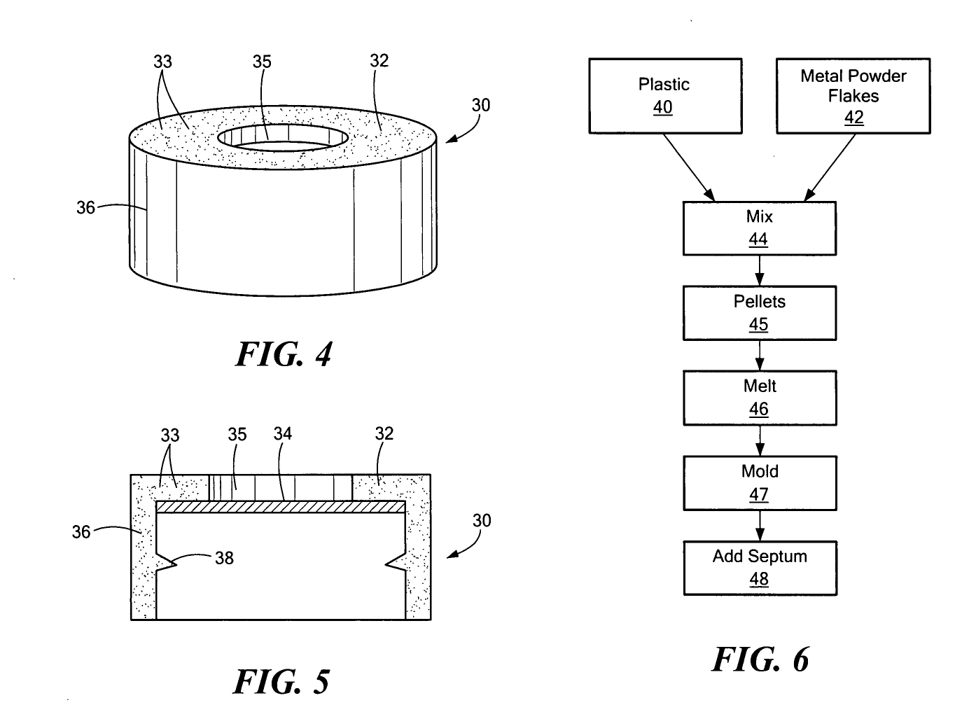

In accordance with the subject invention, cap 30, FIGS. 4-5, in one preferred embodiment, includes top portion 32 including moldable plastic (e.g., polypropylene) with an aperture 35 and septum disk 34 sealing the aperture. Septum 34 may be made of silicone or butyl rubber. Wall 36 of cap 30 depends downwardly from top portion 32. A ferromagnetic substance 33 (e.g., meaning any material attracted to the magnet) is included in at least the plastic material of the top portion 32 of cap 30. In this way, cap 30 is attracted to a magnetic head of a sample of sample handling equipment. Typically, wall 36 also includes ferromagnetic material therein. The size and configuration if cap 30 may vary. Examples include a 9 mm sample vial cap used in chromatography applications and a 24 mm sample vial cap used in environmental studies.

As shown in FIG. 6, plastic material 40 and metal powder and/or flakes or particles 42 are mixed, step 44. The mix is usually a melt from which pellets are produced, step 45. The metal powder and/or flakes can be stainless steel, iron, magnetic iron oxide, or the like. Too little ferromagnetic material results in too low of an attraction force between the cap and the magnetic head of the sample handling equipment. Too much ferromagnetic material may result in difficulty in molding the caps. Particle or flake size may also impact moldability.

In one example, 60-85% metal by weight was added to the plastic material. In one specific example, 70% by weight Ancor 1000, iron power (Hoeganaes Co.) was added to a blend of homopolymer (15% by weight) and copolymer polypropylene (15% by weight). Polymer stabilizers may be added as well, as is known in the art. The relative amounts of the various polymers may vary. Caps can also be produced from other thermoplastic resins (or polymer) which contain ferromagnetic material in an effective magnetic attraction amount. Non-exclusive examples of other thermoplastic resins suitable for the subject invention include: polymethyl pentene, polyacetal, polybutylene terephthlate, polyamide 6, polyamide 66, polyamide 6/12, polyphenylene sulfide, and polyvinylidene fluoride. Thus, Polyacetals, polyesters, polyamides, PPS and/or fluoropolymers may be used for the plastic material. A weight percent range of 60-85% metal powder in polypropylene corresponds to a specific gravity (or density) range of 1.91 to 3.59 grams per cubic centimeter. A specific gravity range from 1.25 to 6.5 grams per cubic centimeter is possible when other thermoplastic resins containing ferromagnetic material are used.

The resulting pellets are then melted, step 46 and the melt is molded step 47 to produce a cap after which a septum is added, step 48. Molding of the cap is advantageously effected the same as a cap made only of plastic.

The septum is then added, step 48 by gluing it in place, by pressing operations, over molding, or the like. In one example, the methods of U.S. Patent Nos. 6,234,335 and/or 5,647,939 (incorporated herein by this reference) are employed to secure the septum in place. Because the preferred cap includes polypropylene, such methods are possible. The mold may include means to form threads such as shown 38 in FIG. 5.

In this way, the same mold used to make purely plastic sample container caps with septums can be used to make metallized plastic caps reducing the cost and labor associated with rendering a plastic cap ferromagnetic in accordance with the prior art.

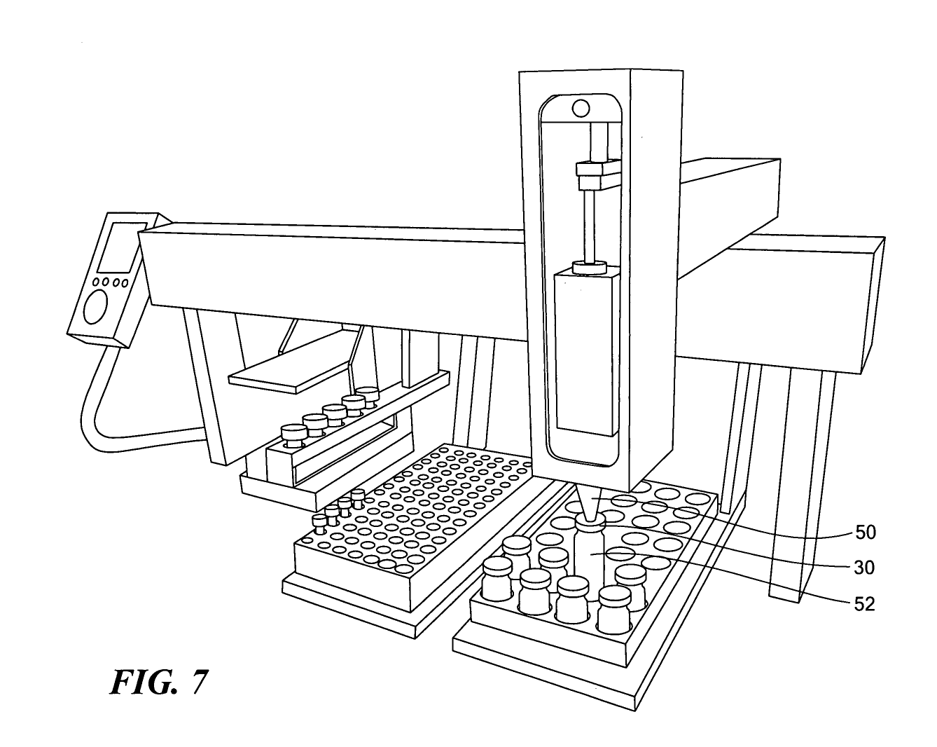

FIG. 7 shows an automated sample handling apparatus handler with magnetic head 50 used to retrieve, transport, and deposit sample vial 52 sealed with cap 30 having septum as described above. Since cap 30 includes a ferromagnetic substance therein, cap 30 is attracted to magnetic head 50. Examples of manufacturers supplying automated sample handling equipment using pick and placement techniques involving magnetic attraction are Leap Technologies, Gerstel, Inc., CETAC Technologies, and others. The result, in the preferred embodiment, is a new plastic vial cap including ferromagnetic material typically made and in a less expensive and less labor intensive manner.

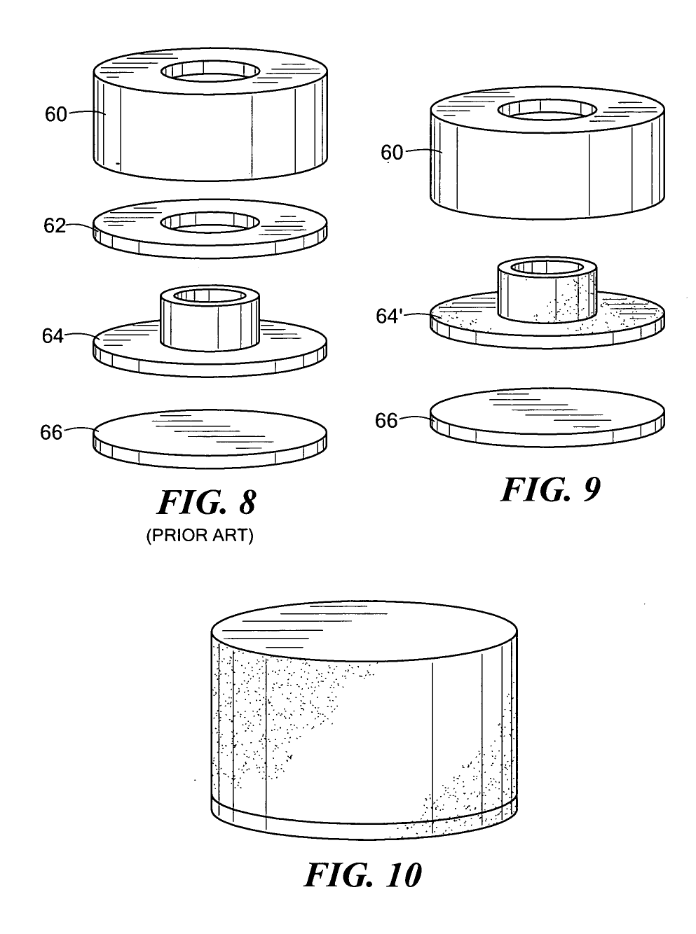

FIG. 8 shows another prior art cap with aluminum crimp portion 60, metal disk 62, plastic insert 64, and septum disk 66. Crimp portion 60, plastic insert 64, and septum disk 66 are standard. Metal disk 62 was added to address the use of magnetic type handlers. Crimp portion 60 is typically made of an easily crimpable material and thus is not usually made of a ferromagnetic or plastic material.

But, in accordance with one example of the subject invention, the ferromagnetic material is added to insert 64′, FIG. 9 using a process wherein metal flakes or powders are added to the stock plastic material of insert 64′ before it is molded into its final shape. Now, metal disk 62, FIG. 8 is not required. Moreover, septum disk 66 can still be joined to insert 64′ using a press-fit, adhesives, or proprietary processes.

In other embodiments, there is no septum. FIG. 10 shows, for example, a plastic snap or screw cap for a vial wherein ferromagnetic material has been added to the plastic material of the cap as discussed above.

Thus, the subject invention is highly versatile: for any style cap with a plastic component (e.g., the cap itself or an insert in a metal cap), ferromagnetic material is added to the plastic component so it is attracted to the magnetic head of the newer handlers. This is in sharp contrast to the way those skilled in the art have modified existing caps to include a ferromagnetic insert.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A sample vial cap comprising:
a top portion made of plastic material and including an aperture;
a septum about the aperture;
a wall depending downward from the top portion; and
a ferromagnetic substance included in the plastic material of the top portion.

2. The sample vial cap of claim 1 in which the wall also includes plastic material with a ferromagnetic substance therein.

3. The sample vial cap of claim 1 in which the top portion and wall are molded using a plastic material including a ferromagnetic substance therein.

4. The sample vial cap of claim 1 in which the ferromagnetic substance includes powders or flakes of metal.

5. The sample vial cap of claim 4 in which the metal includes stainless steel, iron, and/or magnetic iron oxide.

6. The sample vial cap of claim 1 in which the wall includes threads.

7. A sample vial cap comprising:
a top portion made of plastic material and including an aperture;
a septum about the aperture;
a plastic wall depending downward from the top portion; and
metal powders or flakes included in the plastic material of the top portion and the wall.

8. A method of making a sample vial cap, the method comprising:
mixing a ferromagnetic substance with a plastic material;
adding the mixture into a mold configured to produce a sample vial cap with an opening for a septum;
molding the cap; and
adding a septum about the opening.

9. The method of claim 8 in which the ferromagnetic substance includes powders or flakes of metal.

10. The method of claim 9 in which the metal is stainless steel, iron, and/or magnetic iron oxide.

11. An automated sample handling apparatus comprising:
a handler with a magnetic head used to retrieve and deposit sample vials sealed with caps each having a septum;
each said cap including a ferromagnetic substance therein for attraction to the magnetic head.

12. The apparatus of claim 11 in which the cap is made of a molded plastic material with metal powders or flakes mixed therein.

13. The apparatus of claim 11 in which the metal is stainless steel, iron, and/or magnetic iron oxide.

14. A sample vial cap comprising:
a plastic component; and
a ferromagnetic substance added to the plastic component.

15. The cap of claim 14 in which the plastic component includes a top portion with an opening sealed by a septum and a wall depending downward from the top portion.

16. The cap of claim 14 in which the plastic component includes an insert between a top portion with an opening and a septum disk sealing the opening.

17. The cap of claim 14 in which the plastic component includes a solid top portion with a wall depending downward therefrom.

18. A sample vial crimp cap comprising:
a top portion with an opening;
a plastic insert with a ferromagnetic substance therein behind the top portion; and
a septum disk behind the plastic insert.

19. A method automatically handling samples, the method comprising:
forming plastic caps for vials to include a ferromagnetic substance mixed therein;
placing a sample in a vial;
sealing the vial with a said formed plastic cap;
employing a handler with a magnetic head to move said vial via magnetic attraction between the magnetic head and the vial cap.

20. The method of claim 19 in which forming includes adding between 60-85% by weight of the ferromagnetic substance to 15-40% by weight of a polymer composition.

21. The method of claim 20 in which approximately 70% iron powder is added to approximately 30% by weight of a polymer composition.

22. The method of claim 21 in which the polymer composition includes a homopolymer and a copolymer polypropylene.

23. The method of claim 21 in which the polymer composition includes polymethyl pentene.

24. The method of claim 21 in which the polymer composition includes polyvinylidene fluoride.
